(19) United States
(12) Patent Application Publication
(10) Pub. No.: US 2023/0024397 A1
(43) Pub. Date: Jan. 26, 2023

(54) CLASSIFICATION OF MOUSE DYNAMICS DATA USING UNIFORM RESOURCE LOCATOR CATEGORY MAPPING

(71) Applicant: International Business Machines Corporation, Armonk, NY (US)

(72) Inventors: Anton PUZANOV, Mitzpe Ramon (IL); Andrey FINKELSHTEIN, Beer Sheva (IL); Eitan MENAHEM, Beer Sheva (IL)

(21) Appl. No.: 17/380,738

(22) Filed: Jul. 20, 2021

(51) Int. Cl. G06F 16/906; G06N 20/00

(52) U.S. Cl. CPC G06F 16/906; G06N 20/00

(57) ABSTRACT

An example system includes a processor to receive mouse dynamics data of a session to be analyzed and a uniform resource locator (URL) category mapping. The processor can group the mouse dynamics data into a plurality of groups using the URL category mapping. The processor can separately extract features from each of the plurality of groups to generate a plurality of groups of features for the session. The processor can input the groups of features into a trained classification model. The processor can receive an output score from the trained classification model.

### BACKGROUND

The present techniques relate to classification. More specifically, the techniques relate to classification of mouse dynamics data.

Many interactions with a website may be performed using a mouse. Thus, mouse dynamics data is sometimes used for behavior analytics. For example, the mouse dynamics data may include mouse behavior features extracted using event type, time or location on page information. However, some approaches for handling Uniform Resource Locator (URL) data neglect mouse dynamics data. For example, such approaches may extract features only with respect to an entire session. Some approaches use mouse dynamics data with only minimal processing. For example, some approaches extract features with respect to each page's URL. However, these approaches may be sub-optimal, neglecting the URL data results in general patterns which are noisy as behavior patterns are changed for various page types. In addition, extracting features for each page individually may be expensive in terms of computation and storage, and often lack enough data for all pages. Such limited data may result in less valuable statistics. Some approaches may partition the website into URL categories. However, such approaches may not consider behavior patterns extracted from the categories. URL categorization has been addressed in previous research by analyzing the URL expression. For example, URL categorization may include splitting the URL to token with the help of general and domain specific word corpuses.

### SUMMARY

According to an embodiment described herein, a system can include processor to receive mouse dynamics data of a session to be analyzed and a uniform resource locator (URL) category mapping. The processor can also further group the mouse dynamics data into a number of groups using the URL category mapping. The processor can also separately extract features from each of the number of groups to generate a number of groups of features for the session. The processor can input the groups of features into a trained classification model. The processor can also receive an output score from the trained classification model.

According to another embodiment described herein, a method can include receiving, via a processor, mouse dynamics data of a session to be analyzed and a uniform resource locator (URL) category mapping. The method can further include grouping, via the processor, the mouse dynamics data into a number of groups using the uniform resource locator (URL) category mapping. The method can also further include separately extracting, via the processor, features from each of the number of groups to generate a number of groups of features for the session. The method can also include inputting, via the processor, the groups of features into a trained classification model. The method can further include receiving, via the processor, an output score from the trained classification model.

According to another embodiment described herein, a computer program product for classifying mouse dynamics data can include computer-readable storage medium having program code embodied therewith. The computer readable storage medium is not a transitory signal per se. The program code executable by a processor to cause the processor to receive mouse dynamics data of a session to be analyzed and a uniform resource locator (URL) category mapping. The program code can also cause the processor to group the mouse dynamics data into a number of groups using the URL category mapping. The program code can also cause the processor to separately extract features from each of the number of groups to generate a number of groups of features for the session. The program code can also cause the processor to input the groups of features into a trained classification model. The program code can also cause the processor to receive an output score from the trained classification model.

### BRIEF DESCRIPTION OF THE SEVERAL VIEWS OF THE DRAWINGS

FIG. 1A is a block diagram of an example system for training a machine learning model to classify mouse dynamics data using URL category mapping;

FIG. 1B is a block diagram of an example system for classifying mouse dynamics data using a trained machine learning model;

FIG. 2 is an example system for generating a URL category mapping using a clustering model;

FIG. 3A is a block diagram of an example method that can train a machine learning model to classify mouse dynamics data using URL category mapping;

FIG. 3B is a block diagram of an example method that can classify mouse dynamics data using a trained machine learning model;

FIG. 4 is a block diagram of an example computing device that can classify mouse dynamics data using a trained machine learning model based on URL category mapping;

FIG. 5 is a diagram of an example cloud computing environment according to embodiments described herein;

FIG. 6 is a diagram of an example abstraction model layers according to embodiments described herein; and

FIG. 7 is an example tangible, non-transitory computer-readable medium that can classify mouse dynamics data using a trained machine learning model based on URL category mapping.

### DETAILED DESCRIPTION

According to embodiments of the present disclosure, a system can include a processor that can receive mouse dynamics data of a session to be analyzed and a URL category mapping. The processor can group the mouse dynamics data into a number of groups using a uniform resource locator (URL) category mapping. The processor can separately extract features from each of the number of groups to generate a number of groups of features for the session. The processor can input the groups of features into a trained classification model. The processor can receive an output score from the trained classification model. In some examples, the processor can generate a decision based on the output score. Thus, embodiments of the present disclosure enable an improved mouse dynamics analysis (MDA) that takes into account the webpage where the examination happens. Specifically, the embodiments can take into account all possible webpages (or URLs) composing the website, which are grouped into meaningful categories, referred to herein as URL categories. The output of MDA is a set of features containing information about the way the user interacts with every URL category. The extracted features can thus serve as input to a machine learning (ML) model for execution of various tasks such as classification and anomaly detection. In this manner, the embodiments herein enable improved classification and anomaly detection. In particular, the embodiments provide better classification performance by relating the extracted features to each URL category individually, thus increasing the extracted features' statistical power.

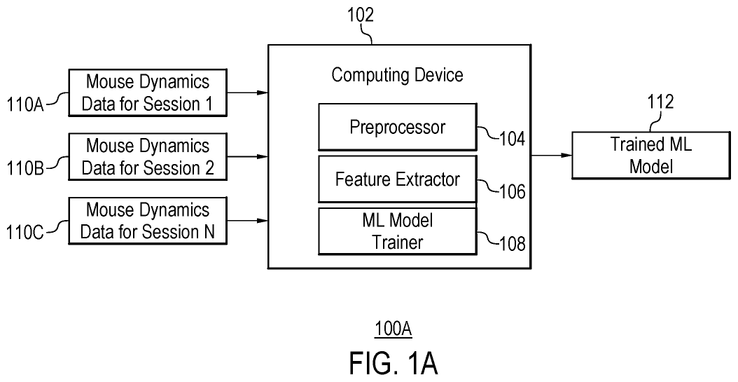

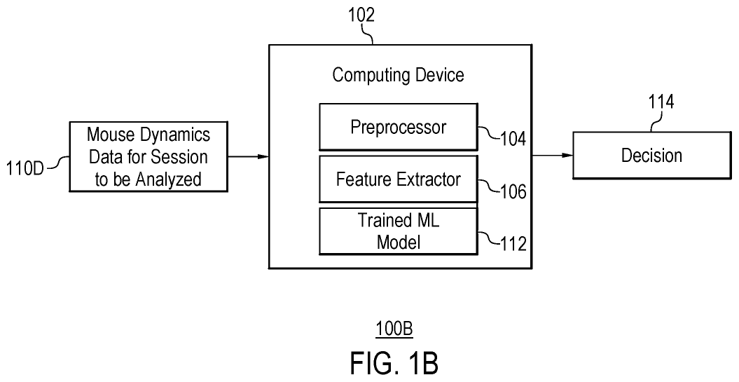

With reference now to FIG. 1A, a block diagram shows an example system for training a machine learning model to classify mouse dynamics data using URL category mapping. The example system is generally referred to by the reference number 100A. The system 100A of FIG. 1A includes a computing device 102. The computing device 102 includes a preprocessor 104, a feature extractor 106, and a machine learning (ML) model trainer 108. The system 100A further includes a set of mouse dynamics data for a number of sessions 110A, 110B, and 110C, shown being received by computing device 102. The system 100A also includes a trained ML model 112 shown being output by the computing device 102.

In the example of FIG. 1A, the collected mouse dynamics data 112 may have the form of (action, time, X_coordinate, Y_coordinate) on each URL of website 110. In various examples, an action may be a string that describes the mouse event. For example, the mouse event may be a move, scroll, or a click. In various examples, the time may be a number of time units the event happened since the first event on that page. For example, the units may be milliseconds, or any other suitable unit. In various examples, the X_coordinate and Y_coordinate are the index of the pixel on the screen or window on the horizontal and vertical axes, respectively. As one partial example of mouse dynamics data, such data may be in the form: {login/new->(move, 0, 101, 234), (move, 5, 122, 215), (click, 10, 122, 215) . . . }, {transfer/new->(move, 0, 569, 421), (move, 5, 585, 447), (click, 10, 585, 447) . . . }.

Still referring to FIG. 1A, the preprocessor 104 may execute a pre-processing on the received mouse dynamics data 110A, 110B, and 110C. In particular, a website corresponding to various URLS included in the mouse dynamics data is partitioned into meaningful segments, referred to herein as URL categories. In various examples, each URL of the website is mapped into one category or into several clusters. For example, each URL may be mapped into one category via classical clustering. In some examples, each URL may be mapped into several clusters via fuzzy clustering. The preprocessor may thus generate a URL to category mapping.

In various examples, URL categories may be formed using three possible methods. For example, a first method may be based on each URL String. In this example, every URL may be mapped to a single category of its own. The URL String approach may work better for small applications where the number of URLs is relatively small. In another approach, the categories may be generated using domain knowledge. In the domain knowledge approach, a human or automatic oracle that already knows how to map each URL to a category may generate the URL to category mapping, and that the mapping is made available to the ML trainer 108. An example of such mapping may be the work of an analyst that maps each URL to a category. A third approach to category mapping may be data driven. The data driven approach can utilize the data collected from the application to create categories. For example, the categorization process of URLs may be based on the strings of the URLs themselves, on the mouse dynamics data, or based on any other type of data. A more detailed example of data driven URL categorization is described with respect to system 200 below. In this approach and during the training phase, the preprocessor 104 may automatically generate and output a URL category mapping to be used by the feature extractor 106.

The feature extractor 106 can execute a feature extraction process based on the URL category mapping and feature extractors that calculate behavioral patterns of the user for the entire session. The feature extractor 106 can group the mouse dynamics data according to the URL category mapping and apply the feature extractor to each one of the categories separately. Thus, each of the categories may have a number of features extracted based on corresponding behavioral patterns. In some examples, where hierarchical clustering model is used to create the URL category mapping, the URLs may be assigned to several categories. The total number of features that are extracted may depend on the original number of features that the feature extractor 106 calculates (N) and the number of categories (K). For example, the total number of features extracted may be: N*K.

In various examples, the feature extractor 106 can calculate statistics of times between mouse events during a session that are applied for each URL category. For example, the statistics may include average time between events, or median time between events, among other suitable statistics. As one example, assuming there are two categories in the URL category mapping, the feature extractor 106 can generate the following features: average time between events in URLs from a first category, average time between events in URLs from a second category, median time between events in URLs from the first category, and median time between events in URLs from the second category. In some examples, the feature extractor 106 can also apply various machine learning techniques, such as filling missing values and scaling. These and any other additional suitable machine learning techniques can be performed before training the model.

The ML model trainer 108 can then train a ML model based on the extracted features to generate a trained ML model 112. For example, after the feature extractor 106 has calculated all features based on the URL category mapping, there may be multiple groups of features for each session. In some examples, the ML model trainer 108 can also apply various machine learning techniques, such as feature selection. This and any other additional suitable machine learning techniques can be performed before training the model. In various examples, each group of features may be related to a single URL category. The ML model trainer 108 can execute a model training stage by one of the following methods.

In some examples, the ML model trainer 108 can merge all features groups to a single dataset and train a single ML model 112. In various examples, the model can be based on any machine learning algorithm. For example, the ML model may be a fully connected neural network, a random forest, a gradient boosted trees or support vector machine (SVM) for the classification task, an Isolation forest, a one-class SVM, or an auto-encoder for outlier detection or linear regression, a Random Forest regressor, or a neural network for regression model, among other suitable ML models.

In some examples, the ML model trainer 108 can train a machine learning model for each of the URL categories and apply an ensemble technique on the models to provide a single decision based on these models. For example, some possible ensemble techniques that can be used include voting, stacking, distribution summation, among other suitable ensemble techniques.

Once the ML model trainer 108 is finished training the model, the system 100A may output a trained ML model 112. In various examples, the trained ML model 112 can be used to analyze mouse dynamics data as described in FIG. 1B.

It is to be understood that the block diagram of FIG. 1A is not intended to indicate that the system 100A is to include all of the components shown in FIG. 1A. Rather, the system 100A can include fewer or additional components not illustrated in FIG. 1A (e.g., additional computing devices, websites, mouse dynamics data, or additional trained ML models, etc.).

FIG. 1B is a block diagram shows an example system for classifying mouse dynamics data using a trained machine learning model. The example system is generally referred to by the reference number 100. FIG. 1B includes similarly numbered elements from FIG. 1A.

In the example of FIG. 1B, once the machine learning model is trained as described in the example of FIG. 1A, the system 100B can execute an operational stage. For example, in the operational stage, the system 100B receives a mouse dynamics data 110D of a suspicious session in question and provide a decision 114 for that session. The decision can be a classification of the session, such as “Legitimate” or “Not Legitimate”, a “legitimacy” score, or whether the session should be considered as an outlier. In various examples, the decision 114 can also be supported with a confidence score that indicates the confidence of the model for the decision.

Still referring to FIG. 1B, the preprocessor 104 can map each visited URL in the mouse dynamics data 110D for the session to a category according to the URL category mapping. In some examples, the preprocessor 104 can map each visited URL in the mouse dynamics data 110D of the session to multiple categories if using hierarchical mapping. In various examples, the preprocessor 104 can use the same mapping that was used to train the model. For example, the same URL categorization passed to or obtained by the preprocessor 104 of FIG. 1A, according to the selected URL categorization technique used by system 100A in training the trained ML model 112.

In various examples, the feature extractor 106 can also calculate features in the same manner as the feature extractor 106 in the training phase of FIG. 1A. In some examples, where techniques such as filling missing values or scaling were applied during the model training, the feature extractor 106 may also apply the same techniques on the data of the session.

The trained ML model 112 can then receive the calculated features from the feature extractor 106 and produce a score. In some examples, where techniques feature selection were applied during the model training, the trained ML model 112 may also apply the same techniques on the data of the session. For example, the score may represent a legitimacy of the session. In some examples, the system 100B can optionally additionally include a decision generator to generate a decision 114 based on the score. For example, if the score is higher than a predefined threshold, then the session is marked as legitimate. Otherwise, if the score is not higher than the predefined threshold, the session can be marked as not legitimate. In various examples, the threshold may be obtained by fine-tuning while considering the number of sessions an organization wants to manually process or by finding a limit on the false positive rate during training phase. In some examples, a policy may also specify what to do with sessions marked as not legitimate. For example, such sessions may be automatically blocked or more deeply inspected either manually or automatically.

It is to be understood that the block diagram of FIG. 1B is not intended to indicate that the system 100B is to include all of the components shown in FIG. 1B. Rather, the system 100B can include fewer or additional components not illustrated in FIG. 1B (e.g., additional computing devices, websites, mouse dynamics data, additional trained ML models, or additional decisions, outputs, etc.).

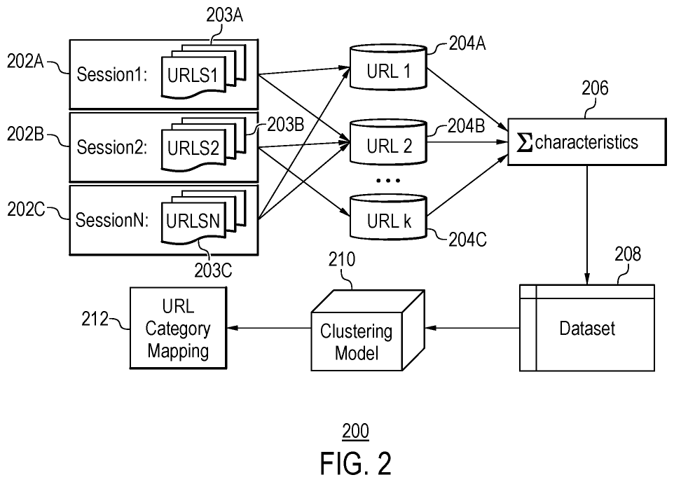

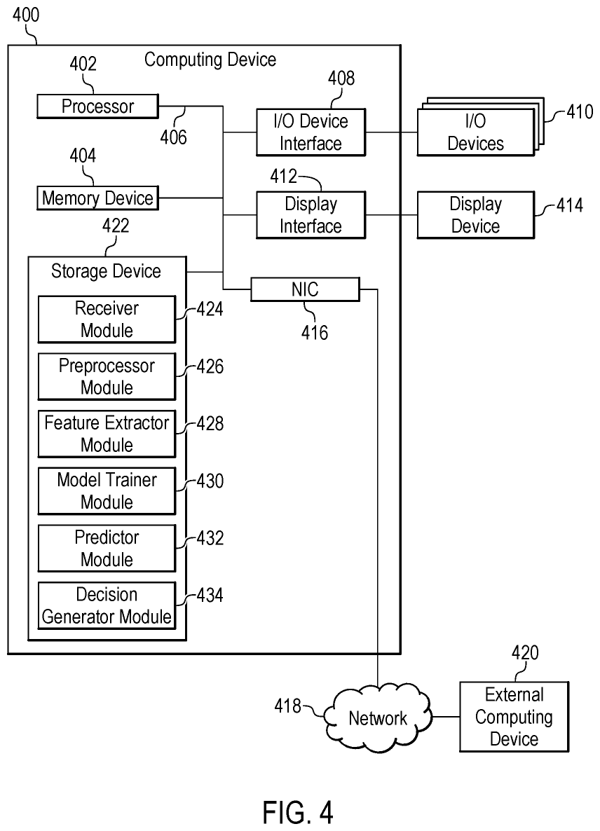

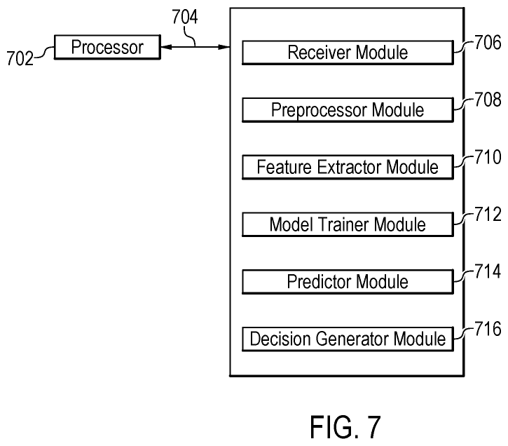

FIG. 2 is an example system for generating a URL category mapping using a clustering model. The example system 200 can be implemented in step 302 of method 300A in system 100A. Moreover, the system 200 can be implemented with any suitable computing device, such as the computing device 400 of FIG. 4 and is described with reference to the system 100 of FIG. 1. For example, the system 200 described below can be implemented by the processor 402 or the processor 702 of FIGS. 4 and 7. In some examples, the system 200 can be implemented in the preprocessor 104, the preprocessor of FIGS. 1A and 1B, the preprocessor module 426 of FIG. 4, or the preprocessor module 708 of FIG. 7.

The example system 200 includes a number of sessions 202A, 202B, and 202C. Each of the sessions 202A, 202B, and 202C includes a group of URLs 203A, 203B, 203C, respectively. The system 200 includes individual URLs 204A, 204B, and 204C. For example, various combinations of the URLs 204A, 204B, and 204C may be included in the groups of URLs 203A, 203B, 203C. The system 200 includes a URL characteristics summarizer 206 shown generating a dataset 208. The system 200 includes a clustering model 210 shown receiving the dataset 208. The system 200 includes a URL category mapping 212 shown being generated by the clustering model 210.

The example system 200 of FIG. 2 is shown using a mouse dynamics categorization approach to generating a URL to category mapping. In particular, the system 200 can apply machine learning clustering technique on mouse dynamics data to create a mapping between URLs and categories.

Given a large set of mouse dynamic data from sessions 202A, 202B, and 202C of various users in the application, the system 200 can extract mouse dynamics events of each URL visited during the session and aggregate the data for each of the URLs 204A, 204B, 204C corresponding to a different page. The system 200 can then aggregate behavior patterns. For example, the behavior patterns may include time on page or mouse movement statistics of each URL 204A, 204B and 204C by user and session. The aggregated behavior patterns may form attributes that represent the behavior of a user during the session on each specific page 204A, 204B, or 204C.

In various examples, the system 200 can then calculate characteristics 206 for each of the URLs 204A, 204B, 204C. The calculated characteristics may represent various behavior patterns for each specific URL. The resulting characteristics for each of URLs 204A, 204B, and 204C may be stored in the dataset 208. For example, the dataset 208 may be a table with rows representing the various URLs 204A, 204B, 204C and columns representing the various calculated characteristics. Thus, in some examples, the rows are the pages of the application and the columns are characteristics of the pages.

In various examples, the system 200 can train a clustering model 210 on the dataset 208. For example, the system 200 may input dataset 208 into a machine learning clustering algorithm that clusters the URLs 204A, 204B, 204C representing different web pages into groups based on the characteristics 206 of the pages. In some examples, the groups of pages that are created by the clustering algorithm are defined as the mapping of pages to categories. For example, each group may be defined as a separate category.

In some examples, the system 200 can train the clustering model using any suitable clustering algorithm. For example, the system 200 can use clustering algorithms such as K-means clustering or density-based spatial clustering of applications with noise (DBSCAN). The trained clustering model 210 is trained to cluster URLs into groups of URLs using the characteristics of the URLs such that each group contains URLs with similar characteristics. In some examples, the clustering model can be a hierarchical clustering model. For example, the hierarchical clustering model may be a custom scheme or a stand-alone algorithm, such as agglomerative clustering, hierarchical DBSCAN (HDBSCAN), or hierarchical K-means clustering. As used herein, a hierarchical clustering model is a model that creates a hierarchy of clusters. For example, URLs in a hierarchical clustering model may be assigned to clusters that can be part of a larger cluster. In this case, each URL can be mapped to more than one cluster. For example, the URL may be mapped to each of the clusters in a particular hierarchy. The use of a hierarchical clustering model enables a benefit from both the more generic URL mapping produced by the high-level clusters that may tend to be large and contain more statistics, and the higher-resolution URL mapping achieved by low-level cluster that may tend to contain less, but more specific information than higher-level clusters.

In various examples, the system 200 can then output a URL category mapping 212 of every URL to the category or categories that the URL was clustered to. The URL category mapping 212 can then be used to extract features from each of the categories as described herein.

It is to be understood that the block diagram of FIG. 2 is not intended to indicate that the system 200 is to include all of the components shown in FIG. 2. Rather, the system 200 can include fewer or additional components not illustrated in FIG. 2 (e.g., additional sessions, URLs, datasets, clustering models, or additional URL category mappings, etc.).

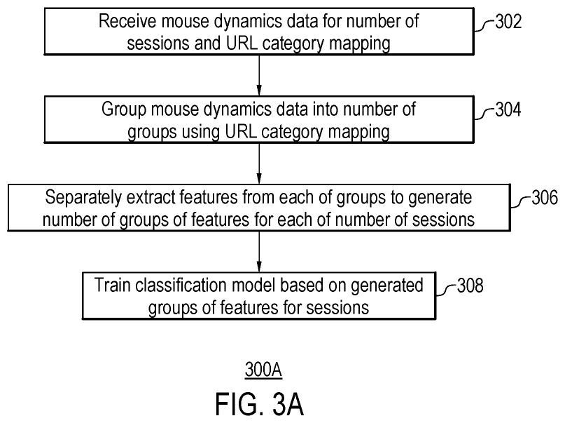

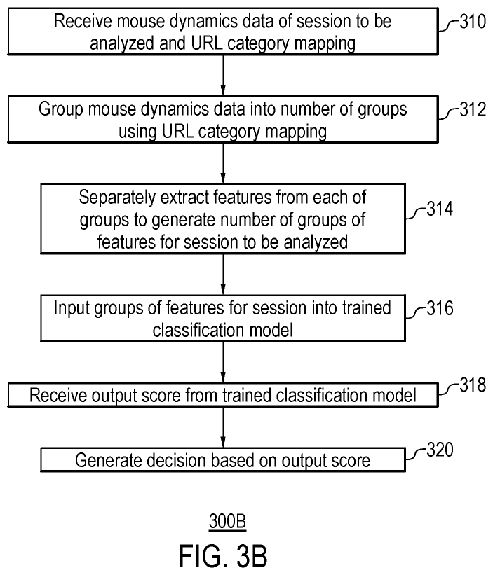

FIG. 3A is a process flow diagram of an example method that can train a machine learning model to classify mouse dynamics data using URL category mapping. The method 300A can be implemented with any suitable computing device, such as the computing device 400 of FIG. 4 and is described with reference to the system 100 of FIG. 1. For example, the methods described below can be implemented by the processor 402 or the processor 702 of FIGS. 4 and 7.

At block 302, a processor receives mouse dynamics data of a number of sessions and a uniform resource locator (URL) category mapping. For example, the number of sessions may be sessions of various users of an application. In various examples, the URL category mapping includes a number of URLs. For example, each URL is mapped to a unique URL category. In some examples, the URL category mapping may be a predetermined mapping. In some examples, the URL category mapping can be automatically generated by the processor based on data collected from an application. In some examples, the URL category mapping is automatically generated by the processor using a machine learning clustering on mouse dynamics data corresponding to a number of sessions of various users of an application.

At block 304, the processor groups the mouse dynamics data into a number of groups using the URL category mapping. For example, each of the groups may be associated with one or more URLs, according to the URL category mapping.

At block 306, the processor separately extracts features from each of the number of groups to generate a number of groups of features for the sessions. For example, one or more features may be extracted from each of the number of groups.

At block 308, the processor trains a classification model based on the generated groups of features for the sessions. In various examples, the processor can merge all feature groups and train the classification model based on the merged feature groups. In some examples, the train a machine learning model for each of the feature groups. For example, the trained classification model includes an ensemble of the trained machine learning models.

The process flow diagram of FIG. 3A is not intended to indicate that the operations of the method 300A are to be executed in any particular order, or that all of the operations of the method 300A are to be included in every case. Additionally, the method 300A can include any suitable number of additional operations.

FIG. 3B is a process flow diagram of an example method that can classifying mouse dynamics data using a trained machine learning model. The method 300B can be implemented with any suitable computing device, such as the computing device 400 of FIG. 4 and is described with reference to the system 200 of FIG. 2. For example, the methods described below can be implemented by the predictor module 432 and decision generator module 434 of FIG. 4 or the predictor module 714 and decision module 716 of FIG. 7.

At block 310, a processor receives mouse dynamics data of a session to be analyzed and a uniform resource locator (URL) category mapping. For example, the session may be a suspicious session to be analyzed for legitimacy. In various examples, the mouse dynamics data may include mouse behavior features extracted using event type, time, or location on page information as well as URLs associated with the mouse behavior features.

At block 312, the processor groups the mouse dynamics data into a number of groups using the URL category mapping. For example, each of the groups may correspond to one or more URLs based on the URL category mapping.

At block 314, the processor separately extracts features from each of the number of groups to generate a number of groups of features for the session. For example, each group may have one or features extracted. In various examples, the extracted features may include statistics of times between mouse events during a session. For example, the statistics may include average time between events, or median time between events.

At block 316, the processor inputs the groups of features into a trained classification model. For example, the trained classification model may be an ensemble classifier or a single classifier. The trained classification model may be the trained classification model of FIG. 3A.

At block 318, the processor receives an output score from the trained classification model. For example, the output score may indicate a legitimacy of the session.

At block 320, the processor generates a decision based on the output score. For example, the decision may be based on a threshold score. In various examples, the decision may indicate “legitimate” or “not legitimate,” or any other suitable labels. In some examples, the threshold score may be predefined. In some examples, the processor can fine-tune the threshold based on a number of sessions an organization wants to manually process. In various examples, the processor can fine-tune the threshold by finding a limit on the false positive rate during the training phase described in FIG. 3A.

The process flow diagram of FIG. 3B is not intended to indicate that the operations of the method 300B are to be executed in any particular order, or that all of the operations of the method 300B are to be included in every case. For example, in some embodiments, block 320 may be excluded. Additionally, the method 300B can include any suitable number of additional operations.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 4 is block diagram of an example computing device that can classify mouse dynamics data using a trained machine learning model based on URL category mapping. The computing device 400 may be for example, a server, desktop computer, laptop computer, tablet computer, or smartphone. In some examples, computing device 400 may be a cloud computing node. Computing device 400 may be described in the general context of computer system executable instructions, such as program modules, being executed by a computer system. Generally, program modules may include routines, programs, objects, components, logic, data structures, and so on that perform particular tasks or implement particular abstract data types. Computing device 400 may be practiced in distributed cloud computing environments where tasks are performed by remote processing devices that are linked through a communications network. In a distributed cloud computing environment, program modules may be located in both local and remote computer system storage media including memory storage devices.

The computing device 400 may include a processor 402 that is to execute stored instructions, a memory device 404 to provide temporary memory space for operations of said instructions during operation. The processor can be a single-core processor, multi-core processor, computing cluster, or any number of other configurations. The memory 404 can include random access memory (RAM), read only memory, flash memory, or any other suitable memory systems.

The processor 402 may be connected through a system interconnect 406 (e.g., PCI®, PCI-Express®, etc.) to an input/output (I/O) device interface 408 adapted to connect the computing device 400 to one or more I/O devices 410. The I/O devices 410 may include, for example, a keyboard and a pointing device, wherein the pointing device may include a touchpad or a touchscreen, among others. The I/O devices 410 may be built-in components of the computing device 400, or may be devices that are externally connected to the computing device 400.

The processor 402 may also be linked through the system interconnect 406 to a display interface 412 adapted to connect the computing device 400 to a display device 414. The display device 414 may include a display screen that is a built-in component of the computing device 400. The display device 414 may also include a computer monitor, television, or projector, among others, that is externally connected to the computing device 400. In addition, a network interface controller (NIC) 416 may be adapted to connect the computing device 400 through the system interconnect 406 to the network 418. In some embodiments, the NIC 416 can transmit data using any suitable interface or protocol, such as the internet small computer system interface, among others. The network 418 may be a cellular network, a radio network, a wide area network (WAN), a local area network (LAN), or the Internet, among others. An external computing device 420 may connect to the computing device 400 through the network 418. In some examples, external computing device 420 may be an external webserver 420. In some examples, external computing device 420 may be a cloud computing node.

The processor 402 may also be linked through the system interconnect 406 to a storage device 422 that can include a hard drive, an optical drive, a USB flash drive, an array of drives, or any combinations thereof. In some examples, the storage device may include a receiver module 424, a preprocessor module 426, a feature extractor module 428, a model trainer module 430, a predictor module 432, and a decision generator module 434. The receiver module 424 can receive mouse dynamics data of a session to be analyzed and a uniform resource locator (URL) category mapping. For example, the URL category mapping includes a number of URLs. For example, each URL may be mapped to a unique URL category. In some examples, the URL category mapping includes a predetermined mapping. In some examples, the receiver module 424 can also receive a threshold. The receiver module 424 can also receive mouse dynamics data of a number of sessions to be used for training. The preprocessor module 426 can group the mouse dynamics data into a number of groups using the URL category mapping. In some examples, the preprocessor module 426 can automatically generate the URL category mapping based on data collected from an application. In some examples, the preprocessor module 426 can automatically generate the URL category mapping using a machine learning clustering on mouse dynamics data corresponding to a number of sessions of various users of an application. The feature extractor module 428 can separately extract features from each of the number of groups to generate a number of groups of features for the session. The model trainer module 430 can train a classification model using groups of features extracted from a number of training sessions. For example, model trainer module 430 can merge feature groups extracted from the groups and train the classification model based on the merged feature groups. In some examples, the model trainer module 430 can train a machine learning model for each of the feature groups. The predictor module 432 can input the groups of features into a trained classification model and receive an output score from the trained classification model. The decision generator module 434 can generate a decision based on the output score. For example, the decision generator module 434 can generate a decision based on whether the output score exceeds the threshold.

It is to be understood that the block diagram of FIG. 4 is not intended to indicate that the computing device 400 is to include all of the components shown in FIG. 4. Rather, the computing device 400 can include fewer or additional components not illustrated in FIG. 4 (e.g., additional memory components, embedded controllers, modules, additional network interfaces, etc.). Furthermore, any of the functionalities of the receiver module 424, the preprocessor module 426, the feature extractor module 428, the model trainer module 430, the predictor module 432, and the decision generator module 434 may be partially, or entirely, implemented in hardware and/or in the processor 402. For example, the functionality may be implemented with an application specific integrated circuit, logic implemented in an embedded controller, or in logic implemented in the processor 402, among others. In some embodiments, the functionalities of the receiver module 424, the preprocessor module 426, the feature extractor module 428, the model trainer module 430, the predictor module 432, and the decision generator module 434 can be implemented with logic, wherein the logic, as referred to herein, can include any suitable hardware (e.g., a processor, among others), software (e.g., an application, among others), firmware, or any suitable combination of hardware, software, and firmware.

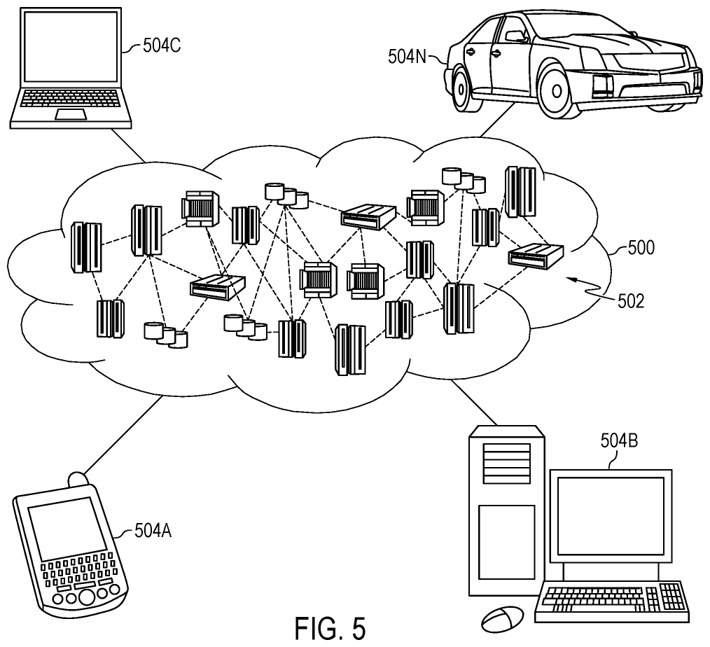

Referring now to FIG. 5, illustrative cloud computing environment 500 is depicted. As shown, cloud computing environment 500 includes one or more cloud computing nodes 502 with which local computing devices used by cloud consumers, such as, for example, personal digital assistant (PDA) or cellular telephone 504A, desktop computer 504B, laptop computer 504C, and/or automobile computer system 504N may communicate. Nodes 502 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 504A-N shown in FIG. 5 are intended to be illustrative only and that computing nodes 502 and cloud computing environment 500 can communicate with any type of computerized device over any type of network and/or network addressable connection (e.g., using a web browser).

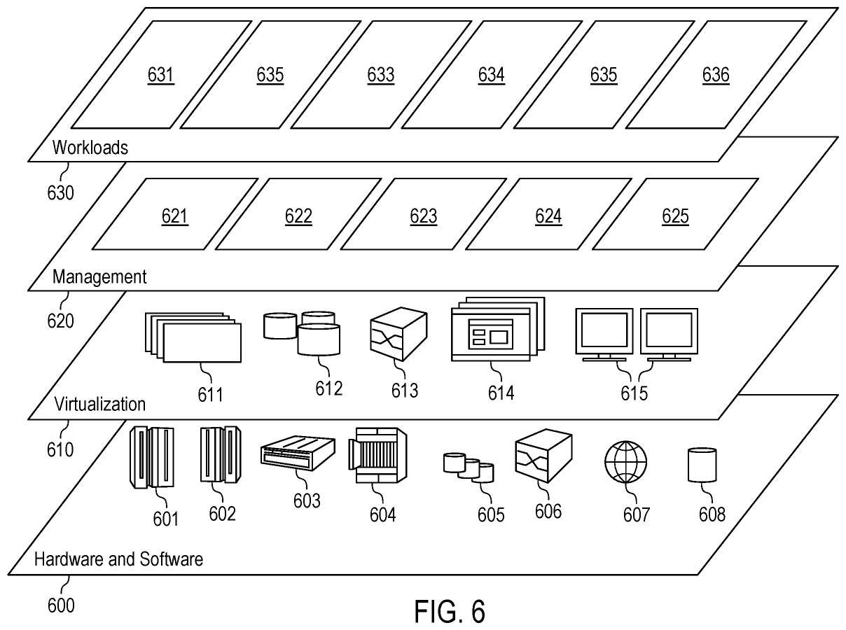

Referring now to FIG. 6, a set of functional abstraction layers provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 600 includes hardware and software components. Examples of hardware components include: mainframes 601; RISC (Reduced Instruction Set Computer) architecture based servers 602; servers 603; blade servers 604; storage devices 605; and networks and networking components 606. In some embodiments, software components include network application server software 607 and database software 608.

Virtualization layer 610 provides an abstraction layer from which the following examples of virtual entities may be provided: virtual servers 611; virtual storage 612; virtual networks 613, including virtual private networks; virtual applications and operating systems 614; and virtual clients 615.

In one example, management layer 620 may provide the functions described below. Resource provisioning 621 provides dynamic procurement of computing resources and other resources that are utilized to perform tasks within the cloud computing environment. Metering and Pricing 622 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 623 provides access to the cloud computing environment for consumers and system administrators. Service level management 624 provides cloud computing resource allocation and management such that required service levels are met. Service Level Agreement (SLA) planning and fulfillment 625 provide pre-arrangement for, and procurement of, cloud computing resources for which a future requirement is anticipated in accordance with an SLA.

Workloads layer 630 provides examples of functionality for which the cloud computing environment may be utilized. Examples of workloads and functions which may be provided from this layer include: mapping and navigation 631; software development and lifecycle management 632; virtual classroom education delivery 633; data analytics processing 634; transaction processing 635; and mouse dynamics data classification 636.

The present invention may be a system, a method and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the techniques. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Referring now to FIG. 7, a block diagram is depicted of an example tangible, non-transitory computer-readable medium 700 that can classify mouse dynamics data using a trained machine learning model based on URL category mapping. The tangible, non-transitory, computer-readable medium 700 may be accessed by a processor 702 over a computer interconnect 704. Furthermore, the tangible, non-transitory, computer-readable medium 700 may include code to direct the processor 702 to perform the operations of the methods 300A and 300B of FIGS. 3A and 3B.

The various software components discussed herein may be stored on the tangible, non-transitory, computer-readable medium 700, as indicated in FIG. 7. For example, a receiver module 706 includes code to receive mouse dynamics data of a session to be analyzed and a uniform resource locator (URL) category mapping. In some examples, the receiver module 706 also includes code to receive a threshold. In some examples, the receiver module 706 includes code to receive mouse dynamics data of a number of sessions to be used for training. A preprocessor module 708 includes code to group the mouse dynamics data into a number of groups using the URL category mapping. The preprocessor module 708 further includes code to automatically generate the URL category mapping based on data collected from an application. In some examples, the preprocessor module 708 also includes code to automatically generate the URL category mapping using a machine learning clustering on mouse dynamics data corresponding to a number of sessions of various users of an application. A feature extractor module 710 includes code to separately extract features from each of the number of groups to generate a number of groups of features for the session. The module 710 also includes code to. A model trainer module 712 includes code to train a classification model. For example, the model trainer module 712 includes code to train the classification model based on a machine learning model for each of the feature groups. For example, a machine learning model may be trained for each of the feature groups and the classification model may be an ensemble classifier. In some examples, the model trainer module 712 includes code to train the classification model based on merged feature groups. For example, the model trainer module 712 may include code to merge all of the feature groups and train the classification model based on the merged feature groups. A predictor module 714 includes code to input the groups of features into a trained classification model and receive an output score from the trained classification model. A decision generator module 716 includes code to generate a decision based on the output score.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. It is to be understood that any number of additional software components not shown in FIG. 7 may be included within the tangible, non-transitory, computer-readable medium 700, depending on the specific application.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
receive mouse dynamics data of a session to be analyzed and a uniform resource locator (URL) category mapping;
group the mouse dynamics data into a plurality of groups using the URL category mapping;
separately extract features from each of the plurality of groups to generate a plurality of groups of features for the session;
input the groups of features into a trained classification model; and
receive an output score from the trained classification model.

2. The system of claim 1, wherein the processor is to generate a decision based on the output score.

3. The system of claim 1, wherein the trained classification model is trained using groups of features extracted from a plurality of training sessions.

4. The system of claim 1, wherein the URL category mapping comprises a plurality of URLs, wherein each URL is mapped to a unique URL category.

5. The system of claim 1, wherein the URL category mapping comprises a predetermined mapping.

6. The system of claim 1, wherein the URL category mapping is automatically generated based on data collected from an application.

7. The system of claim 1, wherein the URL category mapping is automatically generated using a machine learning clustering on mouse dynamics data corresponding to a plurality of sessions of various users of an application.

8. A computer-implemented method, comprising:
receiving, via a processor, mouse dynamics data of a session to be analyzed and a uniform resource locator (URL) category mapping;
grouping, via the processor, the mouse dynamics data into a plurality of groups using the uniform resource locator (URL) category mapping;
separately extracting, via the processor, features from each of the plurality of groups to generate a plurality of groups of features for the session;
inputting, via the processor, the groups of features into a trained classification model; and
receiving, via the processor, an output score from the trained classification model.

9. The computer-implemented method of claim 8, further comprising generating, via the processor, a decision based on the output score.

10. The computer-implemented method of claim 8, further comprising training a classification model to generate the trained classification model, wherein training the classification model comprises:
receiving, via a processor, mouse dynamics data for a plurality of sessions and the URL category mapping;
grouping, via the processor, the mouse dynamics data into a plurality of groups using uniform resource locator (URL) category mapping;
separately extracting, via the processor, features from each of the plurality of groups to generate a plurality of feature groups for the session;
merging, via the processor, all of the feature groups; and
training, via the processor, the classification model based on the merged feature groups.

11. The computer-implemented method of claim 8, further comprising training a plurality of machine learning models to generate the trained classification model, wherein training the classification model comprises:
receiving, via a processor, mouse dynamics data for a plurality of sessions;
grouping, via the processor, the mouse dynamics data into a plurality of groups using the uniform resource locator (URL) category mapping;
separately extracting, via the processor, features from each of the plurality of groups to generate a plurality of feature groups for the session; and
training, via the processor, a machine learning model for each of the feature groups, wherein the trained classification model comprises an ensemble of the trained machine learning models.

12. The computer-implemented method of claim 8, comprising automatically generating the URL category mapping based on data collected from an application.

13. The computer-implemented method of claim 8, comprising automatically generating the URL category mapping using a machine learning clustering on mouse dynamics data corresponding to a number of sessions of various users of an application.

14. The computer-implemented method of claim 8, comprising fine-tuning a threshold used to generate a decision by finding a limit on the false positive rate during a training phase of the trained classification model.

15. A computer program product for classifying mouse dynamics data, the computer program product comprising a computer-readable storage medium having program code embodied therewith, wherein the computer-readable storage medium is not a transitory signal per se, the program code executable by a processor to cause the processor to:
receive mouse dynamics data of a session to be analyzed and a uniform resource locator (URL) category mapping;
group the mouse dynamics data into a plurality of groups using the URL category mapping;
separately extract features from each of the plurality of groups to generate a plurality of groups of features for the session;
input the groups of features into a trained classification model; and
receive an output score from the trained classification model.

16. The computer program product of claim 15, further comprising program code executable by the processor to generate a decision based on the output score.

17. The computer program product of claim 15, further comprising program code executable by the processor to train the classification model based on merged feature groups.

18. The computer program product of claim 15, further comprising program code executable by the processor to train the classification model based on a machine learning model for each of the feature groups, wherein the classification model comprises an ensemble classifier.

19. The computer program product of claim 15, further comprising program code executable by the processor to automatically generate the URL category mapping based on data collected from an application.

20. The computer program product of claim 15, further comprising program code executable by the processor to automatically generate the URL category mapping using a machine learning clustering on mouse dynamics data corresponding to a number of sessions of various users of an application.
